(19) United States
(12) Patent Application Publication
(10) Pub. No.: US 2024/0202906 A1
(43) Pub. Date: Jun. 20, 2024

(54) AUTOMATED OPTICAL INSPECTION FOR AUTOMOTIVE COMPONENTS

(71) Applicants: Stuart Alexander CREWDSON, Shelby Township, MI (US); Darren Andrew WOMACK, LaSalle (CA); Jose Ruben ARROYO GUTIERREZ, San Luis Potosí (MX); Cangji SHI, Troy, MI (US); Arun Prasath PANDIYAN, Rochester Hills, MI (US); Venugopal GARIMELLA, Troy, MI (US); MAGNA INTERNATIONAL INC., Aurora (CA)

(72) Inventors: Stuart Alexander CREWDSON, Shelby Township, MI (US); Darren Andrew WOMACK, LaSalle (CA); Jose Ruben ARROYO GUTIERREZ, San Luis Potosí (MX); Cangji SHI, Troy, MI (US); Arun Prasath PANDIYAN, Rochester Hills, MI (US); Venugopal GARIMELLA, Troy, MI (US)

(21) Appl. No.: 18/287,041

(22) PCT Filed: Apr. 14, 2022
(86) PCT No.: PCT/US2022/024788

§ 371 Date: Oct. 16, 2023

Related U.S. Application Data
(60) Provisional application No. 63/174,703, filed on Apr. 14, 2021.

(51) Int. Cl. G06T 7/00; G06T 19/00; G06V 30/19

(52) U.S. Cl. CPC G06T 7/0008; G06T 7/001; G06T 19/006; G06V 30/19; G06T 2207/10016; G06T 2207/30108

(57) ABSTRACT

An automated inspection system comprises a camera configured to capture an image of a subject item, and a processor in communication with the camera and programmed to recognize the subject item in the image. The processor is configured to determine, from the image, the presence, location, or other properties of a feature of the subject item. The processor may present an augmented reality display as an overlay onto a live image of the subject item. The system may include a portable computing device including the camera and a display screen presenting the augmented reality display with one or more overlays onto a live image of the subject item. The overlays may include icons indicating a feature being recognized as being present and non-defective, or an error icon indicating a missing or defective feature. The portable computing device may include an internal illuminator and/or an external illuminator.

### CROSS REFERENCE TO RELATED APPLICATIONS

This PCT international patent application claims the benefit of U.S. Provisional Patent Application No. 63/174,703, filed Apr. 14, 2021, entitled “Automated Optical Inspection For Automotive Components,” the entire disclosure of which is hereby incorporated by reference in its entirety.

### FIELD

The present disclosure relates generally to a method and system for automated or semi-automated optical inspection of parts and assemblies.

### BACKGROUND

Manual inspection of parts and assemblies by humans can often be time consuming and tedious, which can cause mistakes and poor data documentation.

Inline camera systems and laser scanning systems have been used for inspection purposes. However these systems can require a great deal of infrastructure and they are fixed assets, they cannot be moved around the facility easily to inspect multiple types of parts. They also do not contain a human visually aided inspection. Some handheld systems can provide Augmented Reality (AR) functionality.

### SUMMARY

In accordance with an aspect of the disclosure, an automated inspection system comprises a camera configured to capture an image of a subject item, and a processor in communication with the camera and programmed to recognize the subject item in the image. The processor is configured to determine, from the image, a presence, a location, or a characteristic of a feature of the subject item.

In accordance with an aspect of the disclosure, a method for an automated inspection system comprises: tracking a subject item in 3-dimensional space using a feed from a camera viewing the subject item; determining, by the automated inspection system, at least one of a presence, location, or a characteristic of one or more features of the subject item; comparing the at least one of the presence, location, or the characteristic of the one or more features of the subject item with a data set regarding a design configuration to determine if the one or more features are missing or defective; and reporting the results of the determination regarding each of the one or more features being missing or defective.

### BRIEF DESCRIPTION OF THE DRAWINGS

Further details, features and advantages of designs of the invention result from the following description of embodiment examples in reference to the associated drawings.

FIG. 1 shows a manual inspection of a subject item;

FIG. 2 shows a transparent overlay used to highlight feature locations in a manual inspection process;

FIG. 3 shows the transparent overlay applied to the subject item for manual inspection;

FIG. 4 shows a block diagram of an automated inspection system in accordance with the present disclosure;

FIG. 5 shows an example augmented reality display in accordance with the present disclosure;

FIG. 6 shows an augmented reality display with highlighted edges of an object;

FIG. 7 shows an augmented reality display with highlighted edges of an object;

FIG. 8 shows a weld nut attached to a metal substrate;

FIG. 9 shows a weld stud attached to a metal substrate;

FIG. 10A shows a front side of a test part including several different features;

FIG. 10B shows a back side of the test part of FIG. 10A;

FIG. 11A shows an first example part with several different features;

FIG. 11B shows the first example part of FIG. 11A, indicating detection of a missing spot weld;

FIG. 12A shows a second example part with several different features;

FIG. 12B shows the second example part of FIG. 12A, indicating detection of a missing spot weld and a misplaced spot weld;

FIG. 13 shows a tablet presenting an augmented reality display indicating detection of a plurality of features on a test part;

FIG. 14 shows an augmented reality display indicating a missing weld stud on a test part;

FIG. 15 shows a tablet in action to view a test part and to generate an augmented reality display based on the test part;

FIG. 16A shows a first step and a second step in a workflow for an automated inspection system, in accordance with the present disclosure;

FIG. 16B shows a third step in the workflow for using the automated inspection system, in accordance with the present disclosure;

FIG. 16C shows a fourth step and a fifth step in the workflow for using the automated inspection system, in accordance with the present disclosure;

FIG. 17 is a table describing different variants and options for the automated inspection system, in accordance with various aspects of the present disclosure;

FIG. 18 shows a portable computing device 22 with an external illuminator, in accordance with the present disclosure; and

FIG. 19 shows a flow chart listing steps in a method for an automated inspection system in accordance with the present disclosure.

### DETAILED DESCRIPTION

Referring to the Figures, wherein like numerals indicate corresponding parts throughout the several views, a system and method for automated optical inspection is provided. It is an objective of the present disclosure to provide an automated optical system capable of inspecting a subject item, and to have the software of the system automatically complete the inspection, record, and transfer the results of the inspection. The subject item may be a part or an assembly, such as a part for a vehicle, which may include one or more features. The features may be produced as a result of operations performed upon the subject item, such as addition of components, joining one or more sub-assemblies, and/or operations performed upon the subject item, such as welding, drilling, milling, shaping, coating, or other operations.

The system of the present disclosure uses a combination of feature detection algorithms including but not limited to 3D model based tracking, augmented reality, computer vision detection and machine learning to look at a subject item and automatically determine if all of the specified features meet the requirements in a subject item. The system records inspection data and generates inspection report after the inspection is completed. In case of a defect is detected, the system triggers a signal to reject the part. It can handle varying process and lighting conditions to ensure inspection reliability. This system speeds up the visual inspection process, eliminates operator human errors and has better quality control.

The present disclosure provides for a tablet to perform one or more functions of the automated optical inspection system. In various other embodiments, other hardware components, operating systems and/or vision systems may be used to implement one or more features of the provided automated optical inspection system. The system of the present disclosure can automatically inspect feature defects of subject items before shipping to customer. Inspection features include, for example: weld studs, weld nuts, clinch nuts, spot welds, brackets, part labels, bar codes, quick response (QR) codes, date stamps, clips, holes, splits, baffle attachment, presence and/or form of sealer, presence and/or form of a weld seam, etc.

Inspection categories include but are not limited to: feature presence, size, shape, orientation, position, and/or dimensioning. The system of the present disclosure provides for 3D Tracking. The system can superimpose a visual 3D model onto a live image of the subject item using augmented reality (AR) to initiate inspection workflow. The system of the present disclosure provides for part identification (ID) detection. The system can automatically detect part ID by default. The system may be configured to prompt for and accept input of a manual input in cases where auto-detection fails. The system of the present disclosure provides for feature inspection. The system can use edge intensity, grey scale, computer vision and machine learning algorithms to automatically recognize features and highlight feature defects. The system of the present disclosure may provide user guidance between inspection points/views. The system of the present disclosure may provide inspection reporting. The system may record inspection results and generate inspection report after each inspection cycle. The system can transfer and store the inspection data onto a data server. The system of the present disclosure may provide defective part rejection. For example, the system may be configured to trigger an alarm or a signal to an external device, such as a programmable logic controller (PLC), to reject detective parts when defects are detected.

According to an aspect of the disclosure, the inspection system may include a feature library. For example, known/trained features may be classified in groups. Such a feature library may enable detection and checking of the same or similar features on different parts without changing algorithm or with minimum training.

According to an aspect of the disclosure, a tablet screen is used to display a live image from the camera and the results of the inspection. A computer or processor component to the system is provided to make computations. This processor can be integrated into the tablet or can be separate from the tablet running on one or more different computers, such as one or more distributed processors and/or servers. The system includes a camera, which can be integrated into the tablet or independent of the tablet. The camera is used to capture images which are then analyzed by the software & processor, then displayed on the tablet screen. These components may be integrated into the tablet. Other configurations are possible, and the integration of components may be tailored to meet design requirements of a particular application. For example, the tablet or other equipment with a camera, or an independent camera, connected to the inspection software and hardware components, may be moved manually or robotically while keeping the part to be inspected on a fixture. Alternatively, the camera may be fixed on a jig and the part to be inspected may be manually or robotically moved. In some embodiments, both the camera and the part to be inspected may each be moved around to complete the inspection. In some embodiments, ambient lighting, such as plant over-head or fixture mounted lighting, may be a primary source of lighting used to illuminate the part being inspected. In some embodiments, an illuminator may be mounted to the camera to improve the inspection process.

According to an aspect of the disclosure an inspection system is configured to Automatically perform an optical inspection of parts and components using one or more cameras. Such an automated optical inspection may replace current operator manual inspection. According to a further aspect of the disclosure, the inspection system may generate an inspection report for part traceability. According to a further aspect of the disclosure, a secondary illuminator may be mounted to the one or more cameras. The secondary illuminator may improve feature detection accuracy.

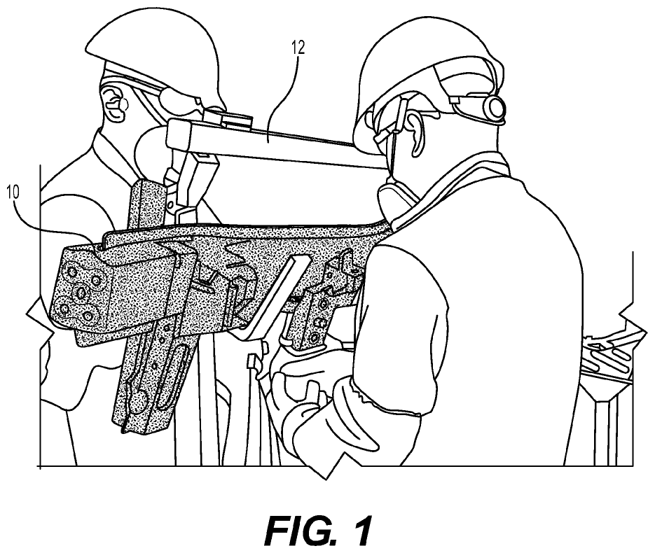

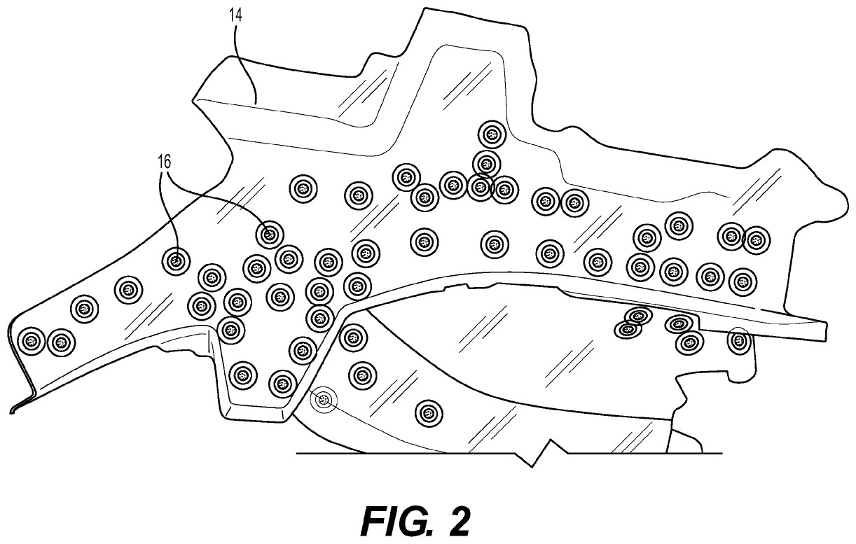

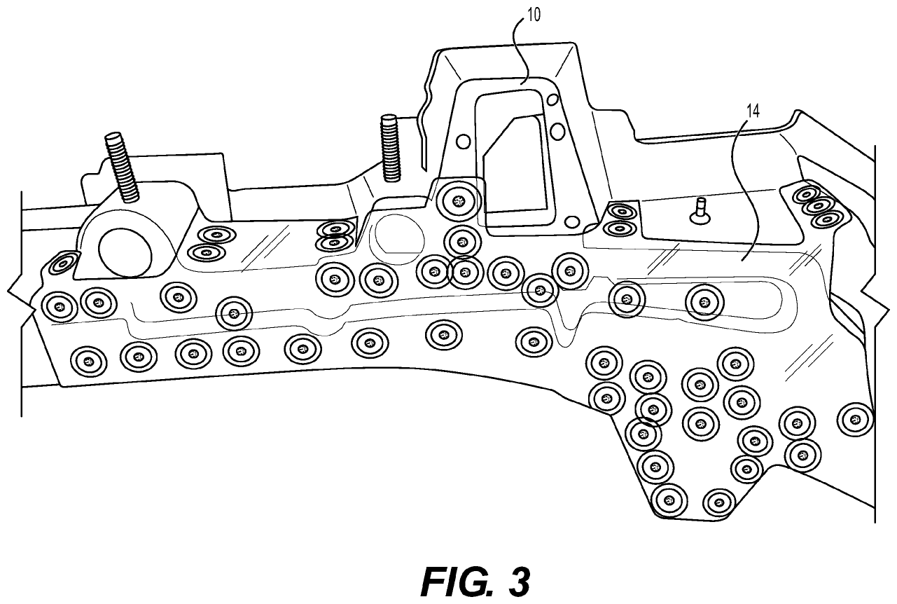

FIG. 1 shows a manual inspection of a subject item 10. The subject item 10 in this example, is a metal part for an vehicle, including a plurality of features, such as welds, holes, welds, seams, etc. Conventional manual inspection of such subject items can be time consuming and tedious, which can cause mistakes and result in errors in data documentation. FIG. 2 shows a transparent overlay 14 used to highlight feature locations in a manual inspection process. The transparent overlay includes several feature identifiers 16, each corresponding to a feature on the subject item 10 to be checked in the manual inspection process. The feature identifiers 16 are each shown as bullseye printed spots. Only a couple of the feature identifiers 16 are labeled to simplify the drawing. FIG. 3 shows the transparent overlay 14 applied to the subject item 10 for manual inspection. For example, the transparent overlay 14 may be used for an inspector to verify presence and position of features, such as studs and weld nuts. Conventional manual inspection may require an inspector to look at each location, one by one, to determine if the feature is present or not. This method of inspection is time consuming, as the inspector must manually check each location. This method of inspection may result in errors, and may limit the number of parts inspected. Transparent overlays 14 may be broken, deformed, or otherwise damaged.

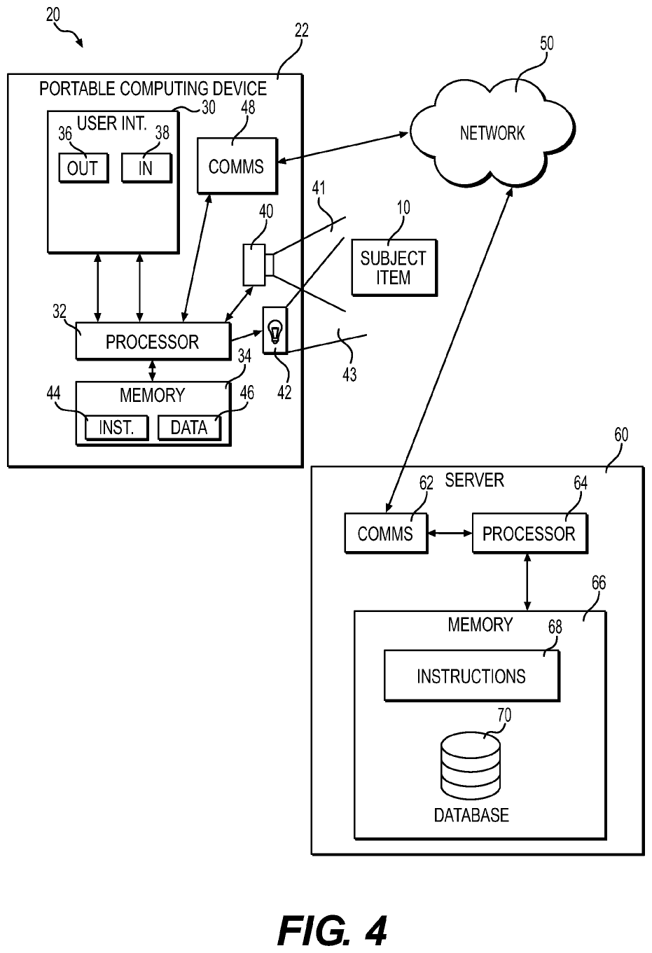

FIG. 4 shows a block diagram of an automated inspection system 20 in accordance with an aspect of the present disclosure. The automated inspection system 20 includes a portable computing device 22 which is configured to perform some or all functions of the inspection system 20. The portable computing device 22 may be a tablet, such as an iPad, or an Android or Windows tablet device. The portable computing device 22 may be another type of device, such as a smartphone, smart glasses, a laptop, netbook, etc. In some embodiments, the portable computing device 22 may be an iPad, due to the high processor performance, long battery life, ease of use, and relatively low cost.

As illustrated in the example embodiment shown in the block diagram of FIG. 4, the portable computing device 22 includes a user interface 30, and a first processor 32 coupled to a first machine-readable storage memory 34. The user interface 30 includes an output device 36 configured to present output data to a user, and an input device 38 configured to receive input data from the user. The output device 36 may include a video display, such as a display screen, a projected display, or a virtual-reality (VR) or augmented reality (AR) image. Alternatively or additionally, the output device 36 may include audio output, such as one or more speakers providing the output in the form of audible signals. The input device 38 may include a touch-screen, a keyboard, mouse, trackpad, trackball, gesture input. Alternatively or additionally, the input device 38 may include hardware and/or software to respond to verbal commands. The output device 36 may be combined with the input device 38, for example, as a touch screen.

The portable computing device 22 includes a camera 40 having a field of view 41 for viewing the subject item 10. The camera 40 may be configured to capture images of the subject item 10 in the visible light spectrum. Alternatively or additionally, the camera 40 may use other non-visible wavelengths, such as infrared (IR) and/or ultraviolet (UV). In some embodiments, the camera 40 may use other imaging techniques, such as laser scanning to determine the 3-dimensional profile of the subject item 10. The camera 40 may be configured to capture video, which may be presented on the output device 36 as a live image. Alternatively or additionally, the camera 40 may be configured to capture still images of the field of view 41, including images of the subject item 10. The video and/or still images captured by the camera 40 may be saved in memory for future use. The processor 32 may be configured to recognize features in the captured images of the subject item 10. The portable computing device 22 includes an internal illuminator 42, such as light-emitting diode (LED) lamp to provide a field of illumination 43 and to illuminate the subject item 10. The internal illuminator 42 may be used to create a better and/or more consistent illumination of the subject item 10 over ambient lighting, which may be dim and/or inconsistent.

As also shown in FIG. 4, the portable computing device 22 includes a first communications interface 48 configured to transmit and to receive data to/from a server 60 via a network 50. The first communications interface 48 may include a wired or a wireless interface, such as, for example, a Universal Serial Bus (USB) or Ethernet interface, or a Wi-Fi, Zigbee, or cellular data radio. The network 50 may include one or more wired and/or wireless segments, which may include, for example, Wi-Fi, Zigbee, Ethernet, infrared, etc.

The first machine-readable storage memory 34 may include one or more of a RAM memory, a ROM memory, flash, or DRAM and may include magnetic, optical, semiconductor, or another type of machine-readable storage. The portable computing device 22 also includes first instructions 44 stored in the first machine-readable storage memory 34 for directing the first processor 32 to cause the output device 36 to present particular output data to the user, and to cause the first processor 32 to receive feedback from the user via the input device 38 and to store data in a first data storage region 46 of the first storage memory 34 and to transmit the data to the server 60. The first instructions 44 may include compiled or interpreted data instructions that cause the first processor 32 to perform operations to enable functions of the automated inspection system 20.

The server 60 includes a second communications interface 62 for communicating with the portable computing device 22 and/or for communicating with the portable computing device 22. The second communications interface 62 may include one or more wired and/or wireless interfaces, which may be the same type or a different type as the first communications interface 48. The server 60 also includes a second processor 64 and a second machine-readable storage memory 66 including second instructions 68 and a second data storage region 70 for storing data. The second data storage region 70 may be organized as a database, as shown on FIG. 4. Alternatively or additionally, data may be stored on an external database that is outside of the second machine-readable storage memory 66 of the server 60. For example, the data may be hosted on a dedicated database.

The second instructions 68 may be configured to cause the second processor 64 to store and analyze the data.

Either or both of the first processor 32 and/or the second processor may be configured process an image captured by the camera 40 and to generate an augmented reality (AR) display for display on the user interface 30. Either or both of the first processor 32 and/or the second processor 64 may be configured process an image captured by the camera 40 and to perform an automated inspection process on the captured image to determine a presence, a location, or a characteristic of a feature of the subject item 10, such as a hole, a weld, a weld nut, a weld stud, or any another feature. The characteristic may include, for example, a type of the feature (e.g. hole or weld or weld nut or weld stud), a size of the feature, rotational or angle of alignment of the feature, one or more details regarding how the feature is attached and/or formed with the subject item 10, etc.

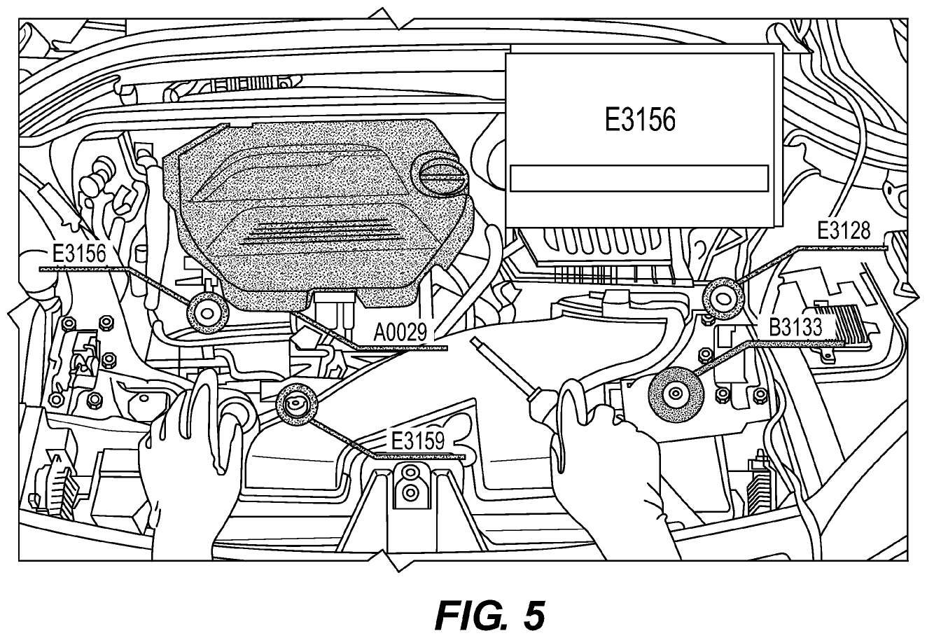

FIG. 5 shows an example augmented reality (AR) display in accordance with the present disclosure. The example AR display may be presented on a head-up display, such as an enhanced goggle or glasses that presents the AR features overlaid onto the user's field of view. Alternatively or additionally, the example AR display may be presented as a live image on a video screen, with the AR features overlaid onto the live video image captured by a camera 40. The AR display of FIG. 5 shows an engine bay of a vehicle. The AR display shows an engine cover that is highlighted with a distinctive color, and which is labeled A0029. The AR display of FIG. 5 also includes other features that are circled and labeled E3156, E3128, and E3159. These circled features may indicated features that are recognized and/or identified. In some embodiments, and as shown in FIG. 5, a feature may be identified as faulty or missing, which may be indicated by an outline other indicator that is a different size, shape, color, and/or thickness. For example, the feature labeled B3135 is circled in red, with a thicker circle than is used for the other identified features. The AR display may use other indicators to show faulty or missing features, such as specific icons, flashing indicators, etc.

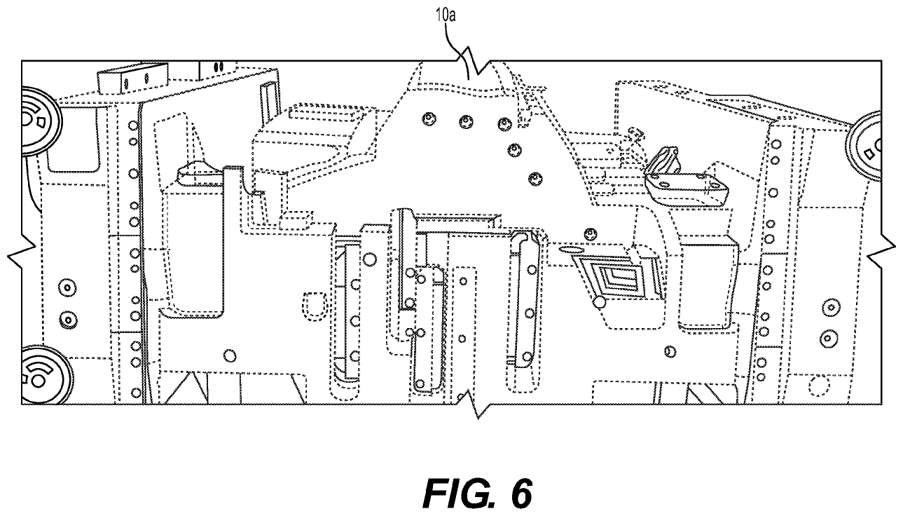

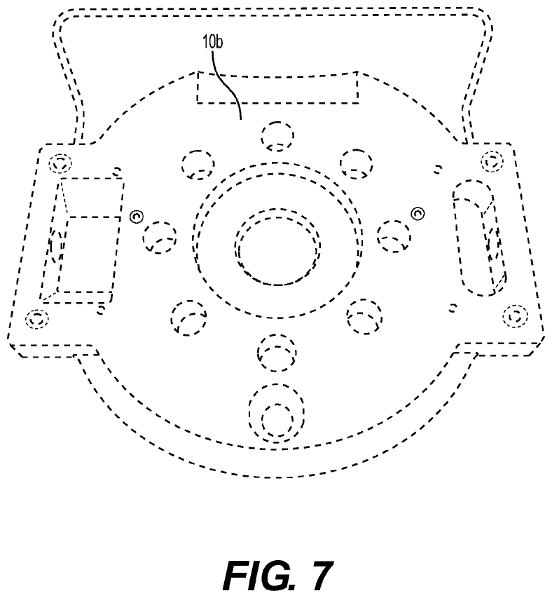

FIGS. 6-7 each show an augmented reality display with highlighted edges of a part 10a, 10b, respectively. In operation, the highlighted edges may not be displayed to a user. However, the highlighted edges may be displayed to the user, or the highlighted edges may be selectively visible. The highlighted edges on FIGS. 6 and 7 show how the automated inspection system 20 may track the position and orientation of the part 10a, 10b by recognizing the edges of the part 10a, 10b. The recognized edges of the part 10a, 10b may be compared to a stored pattern in order to recognize the part 10a, 10b and to determine the position and orientation of the part 10a, 10b. In some embodiments, the automated inspection system 20 may lock onto a reference point or two or more reference points to track the position and orientation of the part 10a, 10b. In other words, the automated inspection system 20 may orientate a coordinate system based on one or more reference features. The reference features may include one or more edges, reference points, or other features.

In some embodiments, the automated inspection system 20 may use artificial intelligence (AI) and/or machine learning (ML) to recognize the subject item 10 and/or to determine if features are present and/or if there are any defects. For example, the automated inspection system 20 may use ML and image processing algorithms to truly understand what a part should look like. In some embodiments, the automated inspection system 20 may include image recognition that is taught what the subject item 10 should look like using a set of training images to develop target images or a model of a conforming item. As subsequent objects are exposed to the automated inspection system 20, the automated inspection system 20 may score the object images, determining how close they are to the model of the conforming item. If the automated inspection system 20 is shown an image of a subject item 10 with features that are missing or otherwise defective, the automated inspection system 20 may be configured take an appropriate action, such as alerting an operator or designating the subject item 10 as non-conforming. The automated inspection system 20 may automatically complete the inspection of the subject item 10 to ensure that functional components are on the subject item 10 and to identify to the operator if any defects are present.

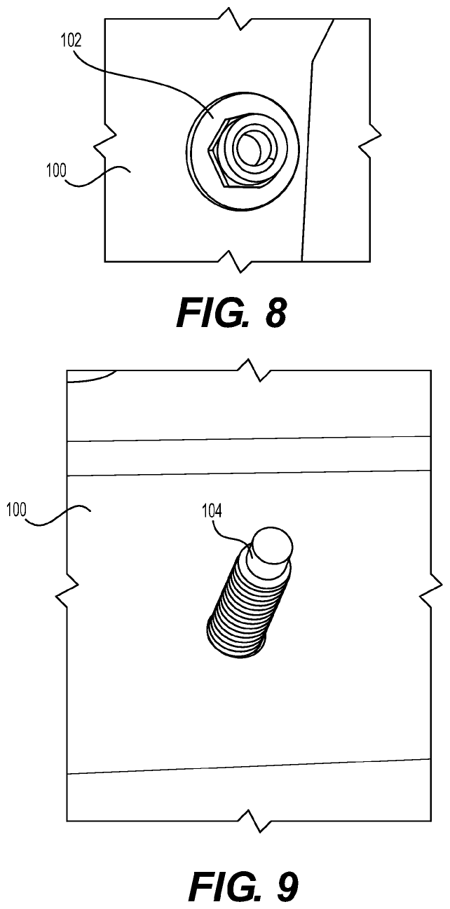

FIG. 8 shows a weld nut 102 attached to a metal substrate of the test part 100. FIG. 9 shows a weld stud 104 attached to a metal substrate of the test part 100.

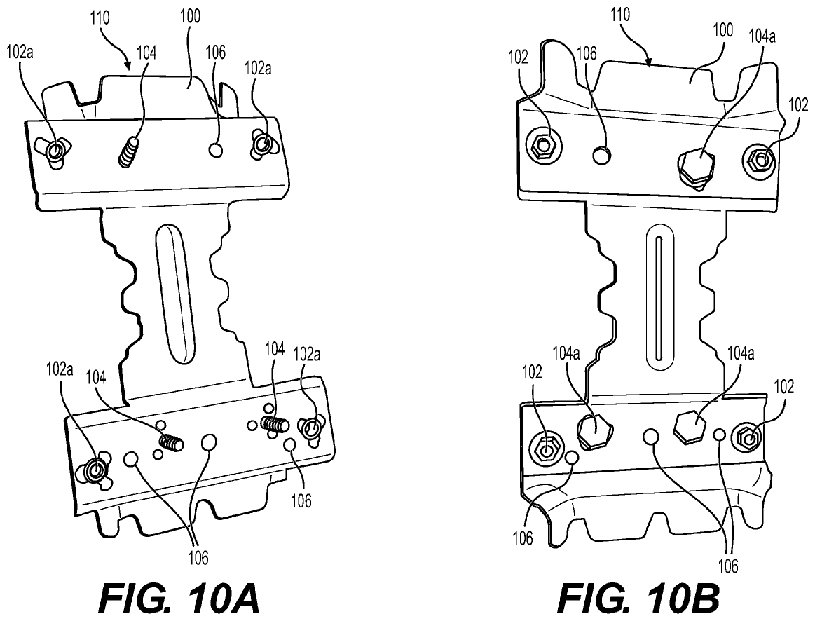

FIGS. 10A-10B show a test part 100 with several different features 102, 102a, 104, 104a, 106. Specifically, FIG. 10A shows a front side of the test part 100, including several weld nut backings 102a, several protruding weld studs 104, and several through-holes 106. FIG. 10B shows a back side of the test part 100 of FIG. 10A, including weld nuts 102 each corresponding to one of the nut backings 102a shown on FIG. 10A. The back side of the test part 100 also includes several weld stud backings 104a each corresponding to one of the weld studs 104 shown on FIG. 10A. This test part 100 may be used to calibrate and/or to test the automated inspection system 20.

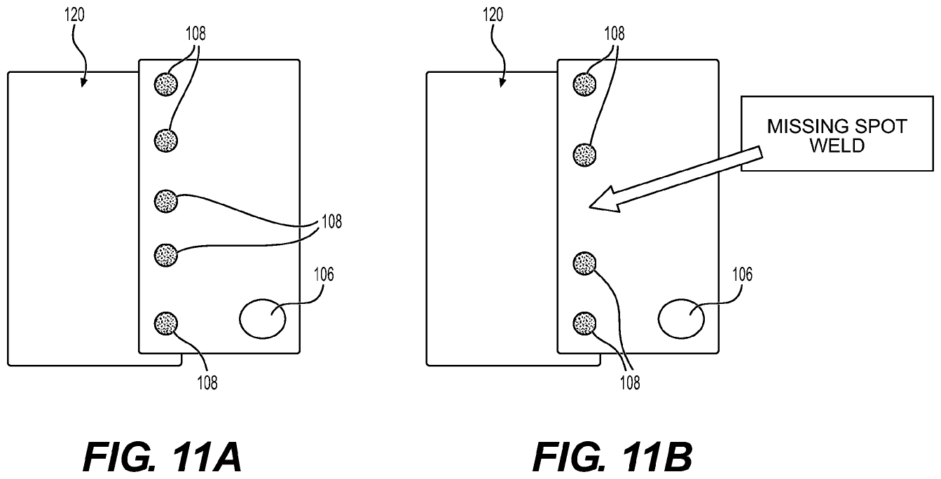

FIG. 11A shows an first example part 120 with several different features 106, 108. The features 106, 108 include a through-hole 106 and several spot welds 108. FIG. 11B shows the first example part 120 of FIG. 11A, indicating detection of a missing one of the spot welds 108. The automated inspection system 20 of the present disclosure may be configured to detect, record, and/or to flag or otherwise show a missing feature, such as the missing one of the spot welds 108.

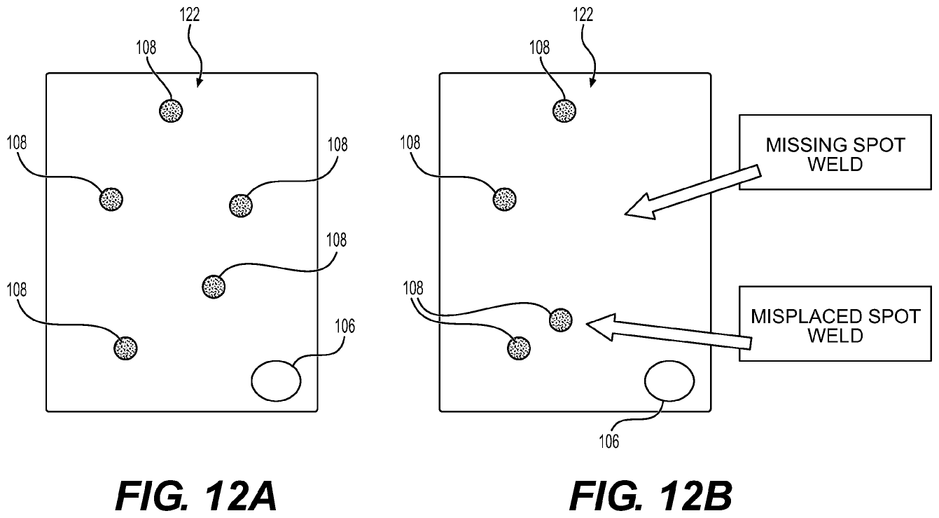

FIG. 12A shows a second example part 122 with several different features 106, 108. The features 106, 108 include a through-hole 106 and several spot welds 108. FIG. 12B shows the second example part 122 of FIG. 12A, indicating detection of a missing spot weld 108 and a misplaced spot weld 108. The automated inspection system 20 of the present disclosure may be configured to detect, record, and/or to flag or otherwise show a misplaced feature, such as the misplaced one of the spot welds 108.

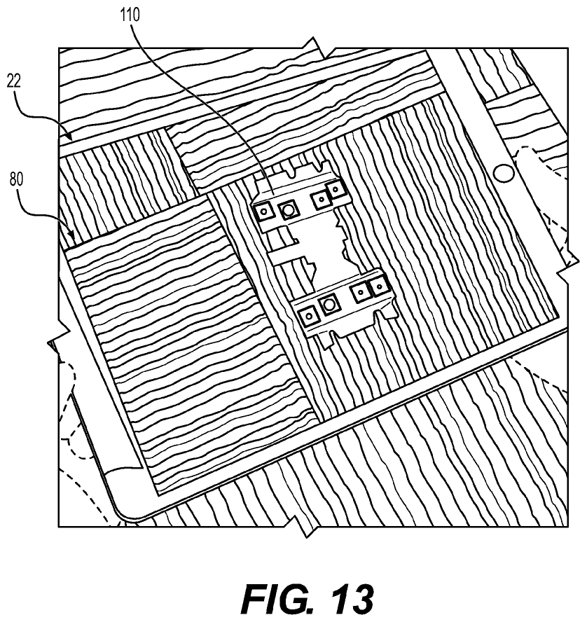

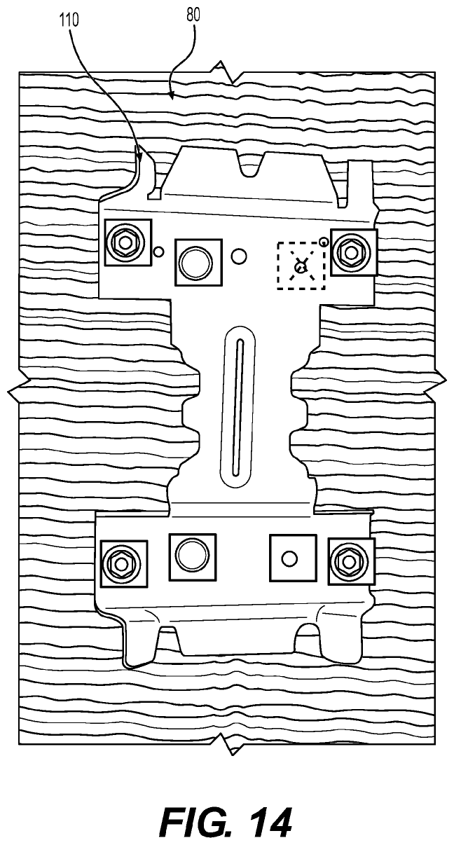

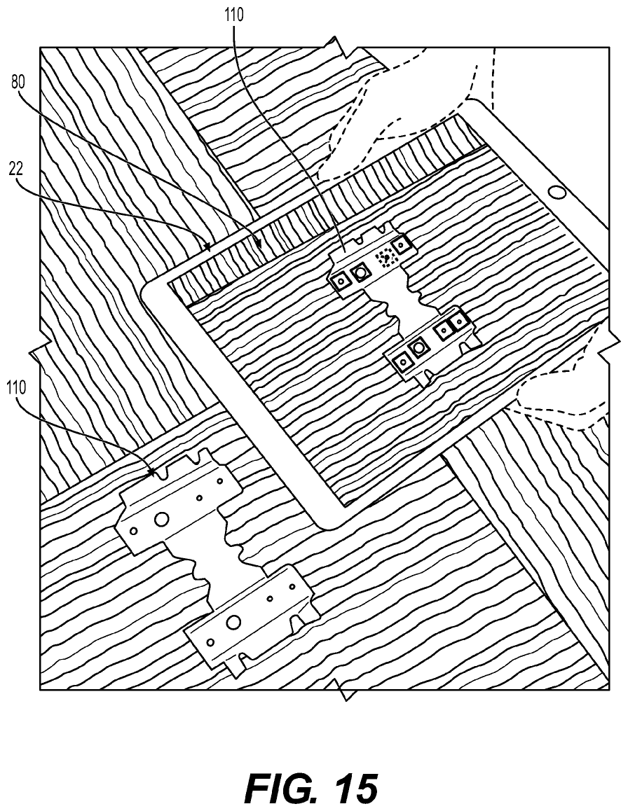

FIG. 13 shows a tablet (i.e. the portable computing device 22) presenting an AR display 80 indicating detection of a plurality of features on a test part 110. FIG. 14 shows an AR display 80 indicating a missing weld stud on the test part 110. Specifically, the AR display 80 indicates features, such as weld studs and weld stud backings 104a, that pass inspection (e.g., being present, in the right location, etc.) surrounded by green squares. The AR display 80 indicates a feature that fails the inspection, such as the missing weld stud in this case, with the corresponding location having a red X surrounded by a red square. These are merely examples, and the visual indicators for passed features and/or for failed features may have other graphical representations. The AR display could include other graphical indicators, such as an indicator that shows that all features of the part pass inspection or a different indicator showing that one or more features of the part fail the inspection. In some embodiments, the AR display 80 could present a graphical representation, such as a yellow triangle, to indicate that the automated inspection system 20 was not able to determine if the feature passes inspection or not. For example, in cases where a particular feature is obstructed or otherwise not visible to the camera 40. FIG. 15 shows a tablet (i.e. the portable computing device 22) in action to view a test part 110 and to generate an AR display 80 based on the test part 110.

In some embodiments, the automated inspection system 20 may be configured to detect and to lock onto a subject item 10 in a video stream captured by a camera 40. The automated inspection system 20 may then compare the detected subject item 10 to a preloaded computer-aided-design (CAD) model of the subject item. In some embodiments, the automated inspection system 20 may then look at predetermined areas within a perimeter of the subject item, and inspect those predetermined areas using edge intensity and grey scale analysis to determine the presence of a plurality of separate features. For example, the automated inspection system 20 may be configured to detect the eight features indicated on FIG. 14. The automated inspection system 20 may be configured to take three pictures of the subject item 10 and to perform a machine learning (ML) analysis on those three pictures to determine the presence of each of the features. The pictures may be still images, which may have a better focus and/or higher resolution than a video stream of the subject item 10. This is merely an example, and the system may use fewer than or greater than three pictures for the ML analysis.

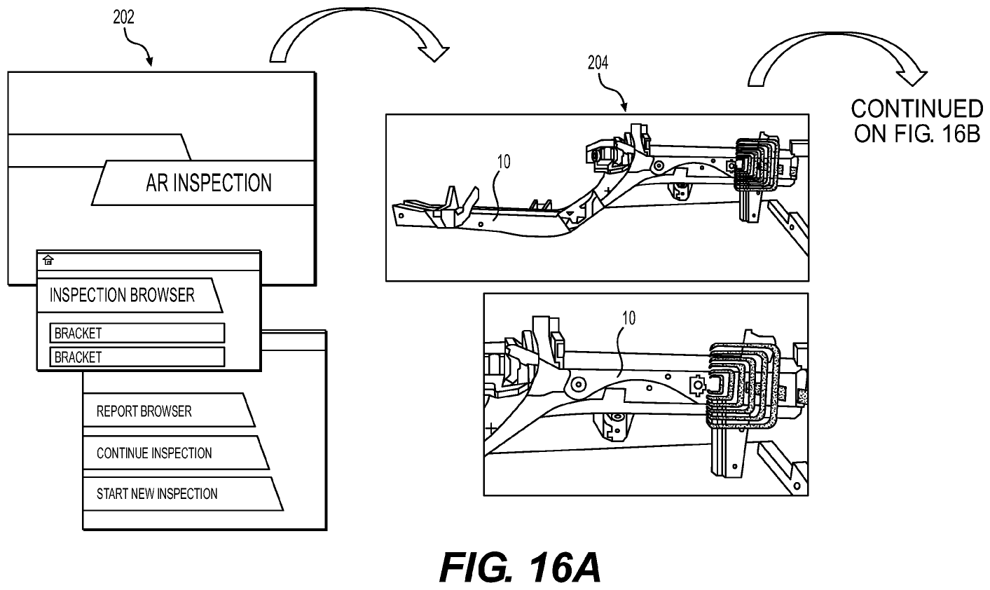

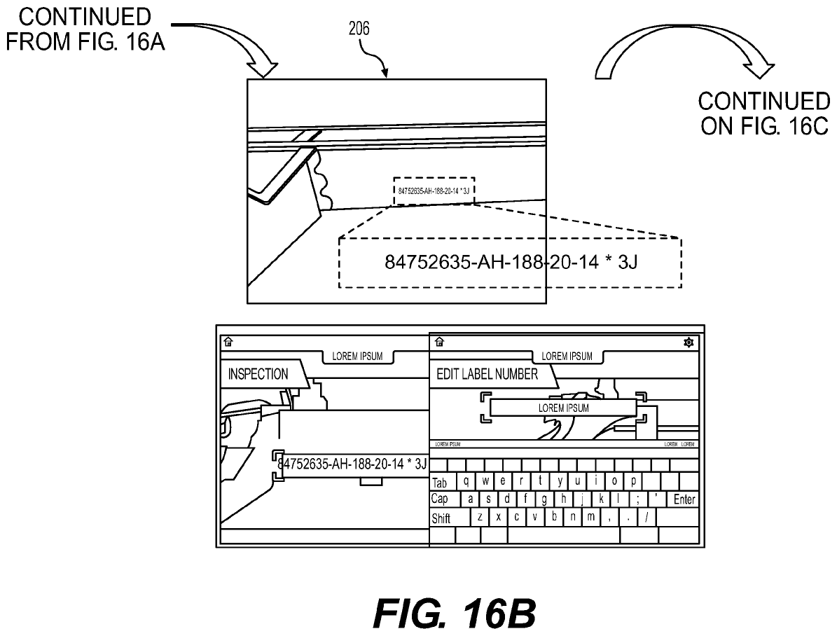

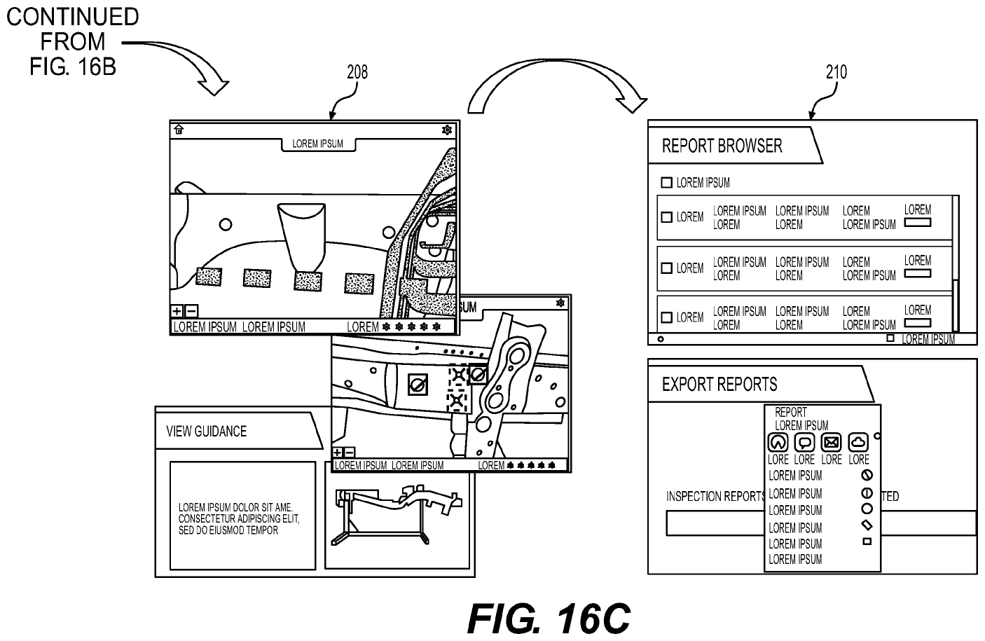

FIG. 16A shows a first step 202 in a workflow for an automated inspection system 20 of the present disclosure. The first step 202 includes presenting a start menu, which may allow an operator to choose one of several functions, such as showing an inspection part list, starting a new inspection, continuing an existing inspection, or to review inspection reports. These are merely examples, and the start menu may include other options.

FIG. 16A also shows a second step 204 in the workflow for using the automated inspection system 20 of the present disclosure. The second step 204 includes tracking the subject item 10 in 3-dimensional (3D) space using a feed from a camera 40. The second step 204 may include using a virtual 3D model, which may be superimposed on an image of the subject item 10, such as a live video feed or a head-up display overlay, using AR.

FIG. 16B shows a third step 206 in the workflow for using the automated inspection system 20 of the present disclosure. The third step 206 includes part identification (ID) detection for determining an ID associated with the subject item to be inspected. In some embodiments, the ID may uniquely identify the subject item, such as by a serial number. In some embodiments, the ID may identify a type or classification of the subject item, such as a model name, number, or code. In some embodiments, the ID may include other information, such as a build date. In some embodiments, the automated inspection system 20 may default to performing automatic part ID detection. The automated inspection system 20 may prompt a user to manually input part ID information, such as a model number or a serial number, in cases when automatic part ID detection fails. Automatic part ID detection may include the automated inspection system 20 using optical character recognition (OCR) to read a human-readable ID number. Additionally or alternatively, automatic part ID detection may use machine-readable codes, such as a barcode, QR code, RFID tag, etc.

FIG. 16C shows a fourth step 208 in the workflow for using the automated inspection system 20 of the present disclosure. The fourth step 208 includes part inspection. The part inspection may include a combination of computer vision and machine learning. The part inspection may automatically recognize features. In some embodiments, the automated inspection system 20 may highlight feature defects, such as missing or faulty features. The fourth step 208 may provide user guidance between inspection points and/or views. For example, the inspection system 20 may prompt the user to point the camera 40 of the portable computing device 22 at different sides of the subject item 10.

FIG. 16C also shows a fifth step 210 in the workflow for using the automated inspection system 20 of the present disclosure. The fifth step 210 includes inspection reporting. The fifth step 210 may include recording inspection results. The inspection results may include details of each feature. Alternatively, the inspection results may include only pass/fail for the entire subject item. In some embodiments, a subject item 10 with passing inspection results for all features may only be recorded as passing the entire subject item 10, and a subject item with one or more failed features may include additional results, such as the failed features, and details as to why each failed features did not pass inspection. Inspection reporting data may be stored locally in the first memory 34 of the portable computing device 22. Additionally or alternatively, inspection reporting data may be transferred from the portable computing device and stored remotely, such as in the second data storage region 70 of the server 60. In some embodiments, the fifth step 210 may include generating a report after each inspection cycle. An inspection cycle may include inspecting one subject item 10, or a batch of two or more subject items. An inspection cycle may be a predetermined period of time, such as one or more times per hour or one or more times in a worker's shift. The fifth step 210 may include triggering a signal to reject defective parts. The triggering symbol may include flagging a particular defective part as being defective and subject to rejection or to another process, such as secondary inspection, or repair.

Table 1, below, describes different variants and options for the automated inspection system 20 in accordance with various aspects of the present disclosure.

TABLE 1

| | Inspection | Inspection | Inspection | |
|---|---|---|---|---|
| | Camera | Software | Operation | Inspected Part |
| Variants | Equipment | Installed | Manually | Part position/ |
| | with a camera | in a tablet | by operator | orientation are |
| | (e.g. Tablet, | | | fixed during |
| | Glasses, etc. | | | inspection |
| | Independent | Installed | Robotically | Part position/ |
| | camera | in other | with Robot | orientation are |
| | | computing | or Cobot | changing during |
| | | hardware | | inspection |

In one example variant, indicated by the top row of the table 1, the inspection camera (i.e. the camera 40) is integrated within or otherwise attached to a portable computing device 22, such as a tablet, AR glasses, etc., and inspection software, which may perform one or more functions of the inspection system 20, is installed on the portable computing device 22 to run on the first processor 32 disposed therein. The functions of the inspection system 20 may include, for example, generating the AR image, identification (ID) detection, feature identification and inspection (i.e., determining if a feature passes inspection by being present and not faulty or if the feature fails inspection by being either not present in the correct location or being otherwise faulty).

In some embodiments, the inspection includes manual manipulation, such as moving the portable computing device 22 around the subject item 10. In some embodiments, the inspection of features is performed and/or validated manually by an operator. In some embodiments, some portion of the feature inspections are performed manually, with the remaining feature inspections being performed automatically by the inspection system 20. Such manual inspections may serve as a check on the automatic inspections. The manual inspections may also help to keep an operator engaged and attentive. In some embodiments, the subject item 10 may have a fixed position and orientation during the inspection. In some other embodiments, the subject item 10 may not be fixed. For example, the inspection system 20 may be used where the subject item 10 is moved along a conveyor system or otherwise moved slowly across the field of view 41 of the camera 40. The camera 40 may be handheld or statically mounted, such as on a tripod or other fixture.

In one example variant, indicated by the bottom row of the table, the inspection camera (i.e. the camera 40) is mounted on a robot or a collaborative robot (a Cobot). In some embodiments, the inspection software may be is installed remotely from the camera 40, such as on the server 60 or on a dedicated computer hardware. In some embodiments, the inspection operation, such as moving the camera 40 relative to the subject item 10, may be performed by the Robot or Cobot. In some embodiments, the subject item 10 may have a position and/or orientation that is changing during the inspection.

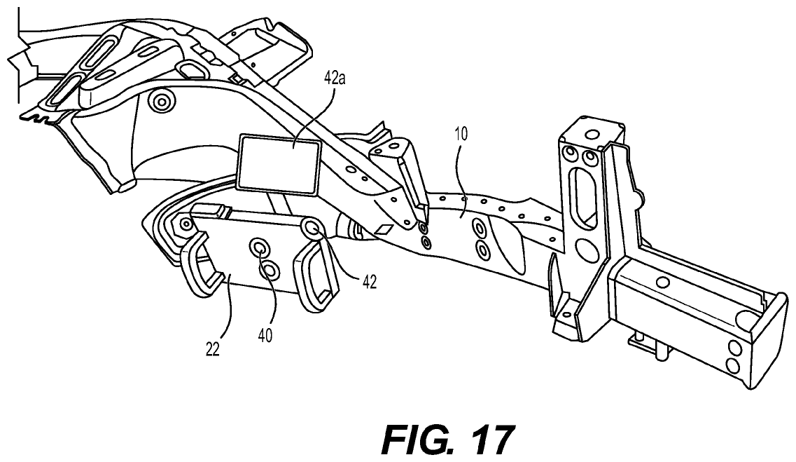

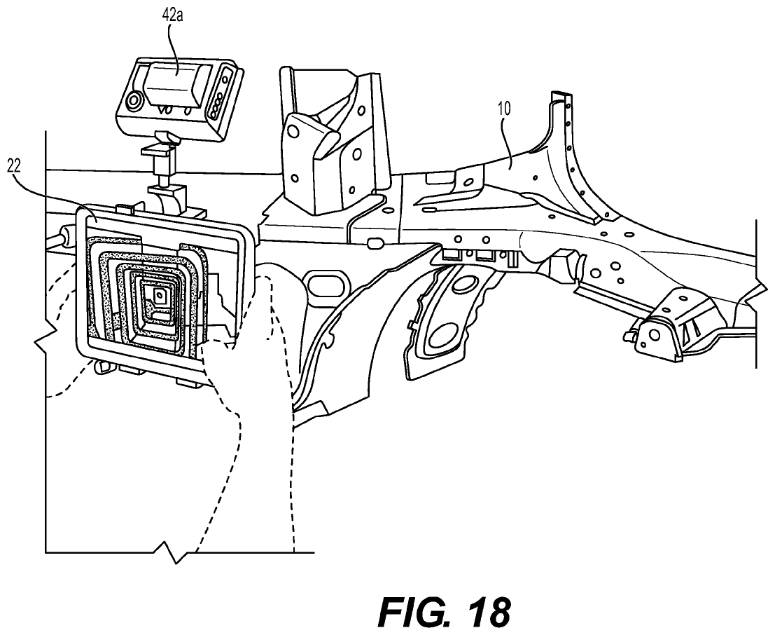

FIG. 17 shows a portable computing device 22 with an external illuminator 42a attached thereto. The external illuminator 42a may be used instead of or in addition to an internal illuminator 42 disposed within the portable computing device 22. The external illuminator 42a may be removably attached to the portable computing device 22. In some embodiments, overhead or fixture lighting may be a primary source of illumination, and the internal illuminator 42 and/or the external illuminator 42a may function as a secondary illuminator to provide additional illumination, which may help to improve inspection accuracy. FIG. 18 shows the portable computing device 22 with the external illuminator 42a in operation.

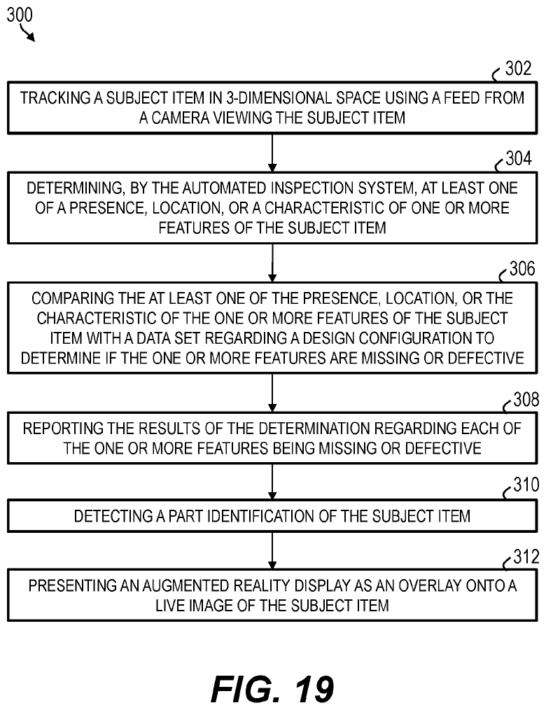

A method 300 for an automated inspection system is shown in the flow chart of FIG. 19. As can be appreciated in light of the disclosure, the order of operation within the method is not limited to the sequential execution as illustrated in FIG. 19, but may be performed in one or more varying orders as applicable and in accordance with the present disclosure. The method 300 includes tracking a subject item in 3-dimensional space using a feed from a camera viewing the subject item at step 302. For example, the processor 32 may execute instructions to track the subject item 10 in 3-dimensional space based on data received from the camera 40. Alternatively or additionally, other hardware and/or software components, such as hardware and/or software that is optimized or otherwise configured for AI or ML tasks may perform one or more functions for performing this method step. Such other hardware and/or software components may be located within the portable computing device 22 and/or external to the portable computing device 22.

The method 300 also includes determining, by the automated inspection system, at least one of a presence, location, or a characteristic of one or more features of the subject item at step 304. For example, the processor 32 may execute instructions to determine the presence, location, and/or characteristics of the subject item 10 based on data received from the camera 40. Alternatively or additionally, other hardware and/or software components, such as hardware and/or software that is optimized or otherwise configured for AI or ML tasks may perform one or more functions for performing this method step. Such other hardware and/or software components may be located within the portable computing device 22 and/or external to the portable computing device 22.

The method 300 also includes comparing the at least one of the presence, location, or the characteristic of the one or more features of the subject item with a data set regarding a design configuration to determine if the one or more features are missing or defective at step 306. For example, the processor 32 may execute instructions to compare the presence, location, and/or the characteristic of the one or more features of the subject item 10 with a data set regarding a design configuration to determine if the one or more features are missing or defective. The data set may be based on computer-aided-design (CAD) data regarding the design of the subject item 10. The data set regarding the design configuration may include information regarding the one or more features, including, for example, tolerances for positioning. Alternatively or additionally, other hardware and/or software components, such as hardware and/or software that is optimized or otherwise configured for AI or ML tasks may perform one or more functions for performing this method step. Such other hardware and/or software components may be located within the portable computing device 22 and/or external to the portable computing device 22.

The method 300 also includes reporting the results of the determination regarding each of the one or more features being missing or defective at step 308. For example, the processor 32 may cause the user interface 38 to present graphical indicators on the output device 36, such as a display screen regarding the one or more features that are determined to be missing or defective and/or those features that are verified as being present and non-defective.

In some embodiments, the method 300 may further include detecting a part identification of the subject item at step 310. For example, the processor 32 may execute instructions to detect and recognize a part identification, such as a printed barcode or serial number of the subject item 10. In some embodiments, this part identification may include optical character recognition (OCR). In some embodiments, this part identification may include identifying the subject item 10 based only on a shape and size of the subject item 10 as determined by the image data from the camera 40. Alternatively or additionally, other hardware and/or software components, such as hardware and/or software that is optimized or otherwise configured for AI or ML tasks may perform one or more functions for performing this method step. Such other hardware and/or software components may be located within the portable computing device 22 and/or external to the portable computing device 22.

In some embodiments, the one or more features of the subject item 10 includes one or more of: a weld stud, a weld stud backing, a weld nut, a weld nut backing, a clinch nut, a spot weld, a bracket, a label, a bar code, a QR code, a date stamp, a clip, a hole, a split, a baffle attachment, sealer, or a weld seam. However, the feature may be another feature, such as an edge or another marking or design feature of the subject item.

In some embodiments, the method 300 may further include presenting an augmented reality display as an overlay onto a live image of the subject item 10 at step 312. For example, the processor 32 may execute instructions to generate graphical image data for the augmented reality display. The processor 32 may also cause the user interface 38 to display the graphical image data for the augmented reality display overlaid on a live image of the subject item 10, from the image data received from the camera 40. Alternatively or additionally, the graphical image data for the augmented reality display may be presented on a transparent substrate, such as a lens of a pair of glasses, so a viewer is presented with the augmented reality display showing the graphical image data overlying their view of the subject item 10. Alternatively or additionally, other hardware and/or software components, such as hardware and/or software that is optimized or otherwise configured for AI or ML tasks may perform one or more functions for performing this method step. Such other hardware and/or software components may be located within the portable computing device 22 and/or external to the portable computing device 22.

In some embodiments, the augmented reality display includes the overlay presented onto a transparent layer, wherein the subject item is visible to a user through the transparent layer, with the overlay aligned with features of the subject item.

The system, methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or alternatively, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices as well as heterogeneous combinations of processors processor architectures, or combinations of different hardware and software, or any other machine capable of executing program instructions.

Thus, in one aspect, each method described above and combinations thereof may be embodied in computer executable code that, when executing on one or more computing devices performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An automated inspection system comprising:
a camera configured to capture an image of a subject item;
a processor in communication with the camera and programmed to recognize the subject item in the image; and
wherein the processor is configured to determine, from the image, a presence, location, or characteristic of a feature of the subject item.

2. The automated inspection system of claim 1, wherein
the feature of the subject item is one of: a weld stud, a weld stud backing, a weld nut, a weld nut backing, a clinch nut, a spot weld, a bracket, a label, a bar code, a QR code, a date stamp, a clip, a hele, a split, a baffle attachment, sealer, or a weld seam.

3. The automated inspection system of claim 1, wherein the processor is further configured to present an augmented reality display as an overlay onto a live image of the subject item.

4. The automated inspection system of claim 3, wherein the augmented reality display includes a live video feed showing the subject item.

5. The automated inspection system of claim 3, wherein the augmented reality display includes the overlay presented onto a transparent layer, wherein the subject item is visible to a user through the transparent layer, with the overlay aligned with features of the subject item.

6. The automated inspection system of claim 1, wherein the processor is configured to generate an inspection report based on determining the presence, location, or characteristic of the feature of the subject item.

7. The automated inspection system of claim 1, further comprising a portable computing device including the camera and a display screen; and
wherein the automated inspection system is configured to present an augmented reality image including one or more overlays onto a live image of the subject item.

8. The automated inspection system of claim 7, wherein the overlays include: no confirmation icons, one or more confirmation icons indicating a feature being recognized as being present and non-defective, or an error icon indicating a missing or defective feature.

9. The automated inspection system of claim 7, wherein the portable computing device further comprises an internal illuminator to illuminate the subject item.

10. The automated inspection system of claim 7, further comprising an external illuminator attached to the portable computing device.

11. A method for an automated inspection system, comprising:
tracking a subject item in 3-dimensional space using a feed from a camera viewing the subject item;
determining, by the automated inspection system, at least one of a presence, location, or a characteristic of one or more features of the subject item;
comparing the at least one of the presence, location, or the characteristic of the one or more features of the subject item with a data set regarding a design configuration to determine if the one or more features are missing or defective; and
reporting the results of the determination regarding each of the one or more features being missing or defective.

12. The method of claim 11, further comprising detecting a part identification of the subject item.

13. The method of claim 11, wherein the one or more features of the subject item includes one or more of: a weld stud, a weld stud backing, a weld nut, a weld nut backing, a clinch nut, a spot weld, a bracket, a label, a bar code, a QR code, a date stamp, a clip, a split, a baffle attachment, sealer, or a weld seam.

14. The method of claim 11, further comprising presenting an augmented reality display as an overlay onto a live image of the subject item.

15. The method of claim 14, wherein the augmented reality display includes the overlay presented onto a transparent layer, wherein the subject item is visible to a user through the transparent layer, with the overlay aligned with features of the subject item.

16. The method of claim 11, further comprising presenting a menu with a list of functions, the functions including showing an inspection part list, starting a new inspection, continuing an existing inspection, or reviewing inspection reports.

17. The method of claim 11, wherein the reporting the results of the determination regarding each of the one or more features being missing or defective further includes generating an inspection report based on determining the at least one of the presence, location, or the characteristic of the one or more features of the subject item.

18. The method of claim 11, further comprising presenting an augmented reality display as an overlay onto a live image of the subject item.

19. The method of claim 18, wherein the augmented reality display includes the overlay presented onto a transparent layer, wherein the subject item is visible to a user through the transparent layer, with the overlay aligned with features of the subject item.

20. The method of claim 18, wherein the overlay includes: no confirmation icons, one or more confirmation icons indicating a feature being recognized as being present and non-defective, or an error icon indicating a missing or defective feature.
